(19) United States
(12) Patent Application Publication
(10) Pub. No.: US 2004/0142657 A1
(43) Pub. Date: Jul. 22, 2004

(54) Location registration using multiple care of addresses

(76) Inventor: Masahiro Maeda, Tokyo (JP)

Correspondence Address: Daniel K. Nichols, Motorola, Inc. - Law Department, 1303 E. Algonquin Road, Schaumburg, IL, 60196, US

(21) Appl. No.: 10/348,266

(22) Filed: Jan. 21, 2003

(51) Int. Cl. H04B 7/15; H04Q 7/20

(52) U.S. Cl. 455/11.1; 455/440; 455/445

(57) ABSTRACT

A communication system in which a mobile node MN communicates with a home agent HA using a first Care-of-Address (CoA-LR) that corresponds to a first wireless coverage area and communicates with a correspondent node (CN) using a second Care-of-Address (CoA-C) that corresponds to a second wireless coverage area. The first wireless coverage area may be a wide area network, such as a cellular based network and the second coverage area may be a small coverage system like a Bluetooth or 802.11 network. The second coverage area is a subset of the first coverage area. The MN does not need to send binding updates to the Home Agent while it stays in the first coverage area, even if it moves from the second coverage area to a third coverage area.

### BACKGROUND OF THE INVENTION

The present invention relates generally to wireless communication systems, and more particularly, to user registration location management for mobile telecommunications systems.

In wireless communications, in order to allow seamless wireless access, the network must be aware of a terminal's location at all times. Therefore location registration is required. Due to the recent explosion in the number of wireless terminals, terminal location registration areas (e.g., cells) are becoming smaller and smaller, especially in metropolitan areas where user density is very high. With the decrease in cell size, movement between cells becomes more frequent and thus location registration becomes more frequent.

In addition, wireless devices are used not only for cellular connections, but also for Internet and other network connections. In order to support mobility to the Internet, Mobile IP technology has been developed. Mobile IP allows Internet users to use their home address when they visit a site with a different network address. That is, each mobile node (MN) is always identified by its home address, regardless of its point of attachment to the Internet. When away from its home access point, the mobile node uses a care-of address (CoA), which is registered with the home agent (HA) and provides information about the current point of attachment to the Internet.

In a mobile IP based wireless network, Binding Update (BU) messages are used for location registration. If the coverage area is very small (e.g., an IEEE 802.11 based network or a Bluetooth based network), or if the mobile node is moving very fast and thus frequently changing cells or coverage areas, the mobile node needs to register its location frequently. Such frequent BU messages from mobile nodes produce a large amount of traffic. Further, when a mobile node is moving between coverage areas, even though it is not engaged in communication, it must still transmit such BU messages. In addition to the increased traffic, the handover process is time consuming and can have a negative impact on seamless communications.

Hierarchical Mobile IP v6 (HMIPv6) introduces a node called a mobility anchor point (MAP). A mobile node moving under the same MAP doesn't need to send BU messages to the HA, which reduces the BU traffic to the mobile node. However, a mobile node still has to send a BU message to the MAP whenever it moves to another IP subnet. Thus, HMIPv6 actually increases the total number of BU messages to the MAP and the HA. More particularly, in the HMIPv6 network, the mobile node must send a BU message to it's HA when it moves to an adjacent MAP domain. The mobile node also has to send a BU message to the MAP whenever it moves to a new cell, regardless of whether it remains in the same MAP domain or enters a new MAP domain. That is, the mobile node has to send a BU message to the MAP when it crosses the border of the cell and it sometimes has to send BU messages to both the MAP and the HA when it crosses the border of the MAP domain. In the MIPv6 a mobile node needs to send only one BU message to the HA when it changes cells. So the HMIPv6 requires a mobile node to send more BU messages than the MIPv6.

Y. Watanabe et al. of NTT DoCoMo Inc. presented a concept of concatenated location registration at the Fall 2001 IEICE general conference in Japan. Concatenated location registration proposes to put a mobile access point in a train or other moving vehicle. Mobile nodes are registered to the mobile access point and a home location register (HLR) manages the mobile nodes location linked to the location of the mobile access point. After a first registration, the mobile node doesn't need to send any more location registration messages to the HLR. This reduces location registration traffic. However, Watanabe et al. did not present any specific procedures for such concatenated location registration.

It would be advantageous to decrease the number of binding update messages, particularly for a mobile terminal moving at high speed.

### BRIEF DESCRIPTION OF THE DRAWINGS

The following detailed description of a preferred embodiment of the invention will be better understood when read in conjunction with the appended drawings. For the purpose of illustrating the invention, there is shown in the drawings an embodiment that is presently preferred. It should be understood, however, that the invention is not limited to the precise arrangement and instrumentalities shown. In the drawings:

FIG. 1 is a diagram for explaining a first example of a location registration and communication process in accordance with the present invention;

FIG. 2 is flowchart of a location registration and communication process in accordance with the first example;

FIG. 3 is a diagram for explaining a second example of the location registration process of the present invention;

FIG. 4 is flowchart of a location registration process in accordance with the second example;

FIG. 5 is a diagram for explaining a third example of the location registration process of the present invention; and

FIG. 6 is flowchart of a location registration process in accordance with the third example.

### DETAILED DESCRIPTION OF PREFERRED EMBODIMENTS

The detailed description set forth below in connection with the appended drawings is intended as a description of the presently preferred embodiment of the invention, and is not intended to represent the only form in which the present invention may be practiced. It is to be understood that the same or equivalent functions may be accomplished by different embodiments that are intended to be encompassed within the spirit and scope of the invention. In the drawings, like numerals are used to indicate like elements throughout.

In one embodiment, the present invention provides a wireless communication method including the steps of a mobile node (MN) receiving a plurality of Care-of-Addresses (CoA) from a corresponding plurality of routers when the MN enters a coverage area of the routers; the MN selecting one of the plurality of CoAs based on first predetermined criteria; the MN registering the selected CoA as a location CoA (CoA-LR) with a Home Agent (HA) via a binding update message; the MN receiving a packet from a correspondent node (CN) via the HA; the MN selecting a link for communication with the CN based on second predetermined criteria; and the MN sending a binding update message to the CN specifying a communication CoA (CoA-C) that allows the MN and the CN to communicate directly with each other.

In another embodiment, the present invention is a wireless communication method including the steps of a home agent (HA) communicating with a mobile node (MN) using a location Care-of-Address (CoA-LR) and a correspondent node (CN) communicating with the MN using a communication Care-of-Address (CoA-C). The COA-LR designates a first wireless coverage area and the COA-C designates a second wireless coverage that is a sub-network of the first wireless coverage area.

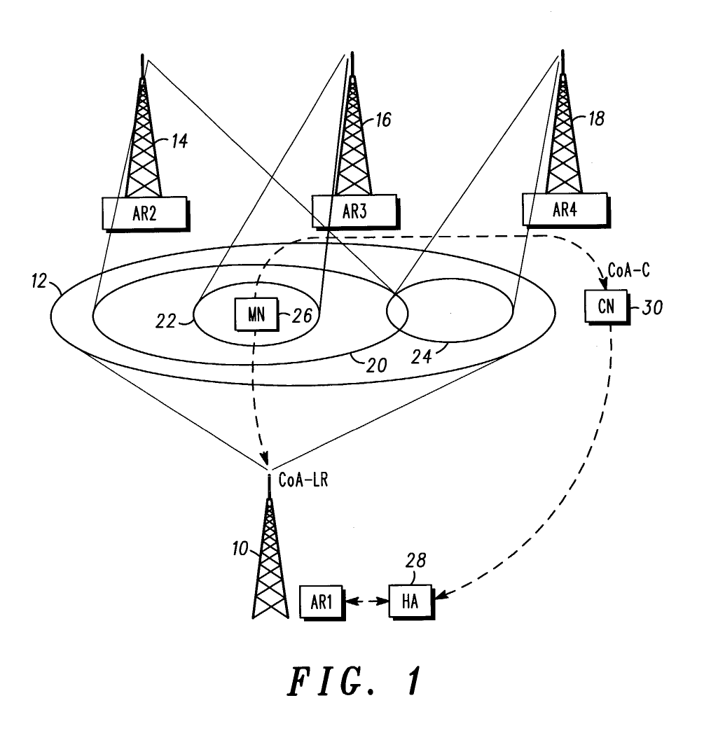

Referring now to FIG. 1, a schematic diagram illustrating a network configuration for explaining a location registration process in accordance with the present invention is shown. The network configuration includes a first access router AR1 and cellular base station 10 that define a first coverage area or cell 12. In this example, the first coverage area 12 is a wide coverage system, like a paging system, a 2G or 3G cellular system, or a satellite system. The base station 10 and access router AR1 are of a type well known to those of skill in the art. The network configuration also includes second, third and fourth access routers AR2-AR4 and base stations 14, 16, 18 that define respective second through fourth coverage areas 20-24. The second through fourth coverage areas 20-24 are small coverage areas, such as 802.11 or Bluetooth type wireless network areas. Each of the second through fourth coverage areas 20-24 is a subset of the first coverage area 12. Further, the third coverage area 22 is a subset of the second coverage area 20. The small coverage areas 20-24 generally provide a faster connection at a lower cost than the connection provided via the base station 10.

A mobile node MN 26, which may be a cellular telephone, such as a 3G cellular telephone, a PDA, or a laptop computer, is shown in the second coverage area 22. As is understood by those of skill in the art, when the MN 26 is in the coverage area 22, it is in communication with the base station 16 and when the MN 26 is in the coverage area 24, it is in communication with the base station 18. The mobile node 26 preferably uses Mobile IPv.6 for mobility management. The MN 26 may move from one coverage area to another and continue communicating via the network. The MN 26 is a dual-mode terminal capable of communication by cellular service and hot spot service. Usually the cellular service and hot spot service are managed by the same operator and roaming between the two services is permitted.

Mobile IP assumes that the MN 26 has a permanent IP address belonging to a sub-network, called the home network (HN), where it can be reached via standard Internet routing. Any other sub-network in which the mobile host may roam is called a foreign network (FN) and a terminal or server that is communicating with a mobile node is known as a correspondent node (CN). A home agent (HA) 28 is shown in communication with the first base station 10 and access router AR1. The HA 28 serves as an edge router, directing traffic to mobile nodes via foreign agents located within the service provider's network. A correspondent node CN 30 is also shown.

According to the present invention, the MN 26 obtains several CoAs from the access routers AR1, AR2, and AR3 when it enters the coverage area 22. That is, the MN 26 receives a CoA for each of the coverage areas or sub-nets in which it is located. In FIG. 1, the MN 26 is shown in coverage areas 12, 20 and 22, so it receives CoAs for each of these areas. The MN 26 selects one of the plurality of CoAs it has received based on a first predetermined criteria. The first predetermined criteria can be set by the wireless system provider. The first predetermined criteria may, for instance, be based on the size of the coverage area, bandwidth or speed of the coverage area, or QoS factors. In the present example, the MN 26 selects a CoA provided by the AR1 because AR1 covers a wider area than AR2 and AR3. The MN 26 registers with the home agent HA 28 using the selected CoA via a BU message. The registered CoA is called a COA-LR (Care of Address-Location Registration). When the correspondent node CN 30 wants to communicate with the MN 26, the CN 30 sends a packet to the home address of the MN 26. The home agent HA 28 intercepts the packet and forwards it to the COA-LR. After the MN 26 has received the packet sent by the CN 30 and forwarded by the HA 28, the MN 26 selects the most appropriate wireless link for communicating with the CN 30 based on some predetermined criteria and the CoA associated with the selected wireless link and sends a BU message to the CN 30 to register a COA-C (Care of Address-Communication). The predetermined criteria for selecting the link to communicate with the CN 30 may be based on the bandwidth of the available links or other QoS requirement. Another method would be for router advertisement messages to include a priority field that indicates the coverage area size, bandwidth, or other features of access routers. The MN then selects the CoA-C based on this priority field. In this example, the MN 26 selects the small coverage system of base station 16 and sends the BU message to the CN 30 via the base station 16 and AR3. Thereafter, packets are transmitted between the MN 26 and the CN 30 directly via the base station 16 and AR3.

When the MN 26 moves to an adjacent cell, such as the coverage area 24, the MN 26 updates the binding cache in the CN 30 by sending a BU message to the CN 30, indicating its new CoA-C as the CoA associated with AR4. However, the MN 26 does not to send a BU message to the HA 28 as long as it remains under the first coverage area 12 of its selected CoA-LR. That is, because the AR1 that provided the CoA-LR to the MN 26 covers a large area, the MN 26 doesn't need to send BU messages whenever it moves to an adjacent cell so long as the MN 26 remains in the wide coverage area 12. Thus, the traffic caused by BU messages is reduced. Note, however, that since the MN 26 is still registered with the AR1 and within the coverage area 12, the MN 26 can still receive messages from the AR1. For example, a paging message directed to the MN 26 is sent via the HA 28 using the COA-LR, while a message from the CN 30 is sent to the MN 26 using the COA-C. Thus, according to the present invention, the MN 26 has a separate link for location registration and paging, which is different from the link for communication.

Referring now to FIG. 2, a flowchart of the communication process discussed above with reference to FIG. 1 is shown. At a first step 32, the MN 26 enters the wide coverage area 12, which has one or more small coverage areas therein, such as the coverage areas 20, 22 and 24. At step 34, the MN 26 receives a Care-of-Address (CoA) for each of the coverage areas in which it is located. In this case, the MN 26 receives three CoAs, one for the coverage area 12, one for the coverage area 20 and one for the coverage area 22. At step 36, after receiving the three CoAs, the MN 26 selects one, using predetermined criteria such as the size of the coverage area, bandwidth, or QoS. For example, router advertisement messages may include a priority field that indicates the coverage area size of access routers and the MN 26 selects the COA-LR based on this priority field. In the presently preferred embodiment, the MN selects the network with the widest coverage area, which in this case is the coverage area 12. At step 38, the MN 26 registers with its home agent HA 28 using the selected CoA via a BU message. The registered CoA is called a COA-LR (Care of Address-Location Registration). More specifically, the MN 26 sends a BU message to the access router AR1.

At step 40, the MN 26 receives a communication from a correspondent node CN 30 by way of the HA 28 and AR1. The CN 30 sends a packet to the home address of the MN 26. The home agent HA 28 intercepts the packet and forwards it to the COA-LR, which is at the AR1, and AR1 forwards the packet to the MN 26. At step 42, the MN 26 selects the most appropriate wireless link and its associated CoA for communicating with the CN 30 based on some predetermined criteria, such as based on QoS. At step 44, the MN 26 sends a BU message to the CN 30 to register the selected CoA as a CoA-C (Care of Address-Communication). In this example, the MN 26 sends a BU message specifying AR3 and base station 16 as its COA-C. As previously discussed, the predetermined criteria for selecting the link to communicate with the CN 30 may be based on the bandwidth of the available links or other QoS requirement. At step 46, the MN 26 and the CN 30 communicate directly with each other via the base station 16 and the AR3. Step 48 indicates that if the MN 26 moves out of the coverage area 22, for instance, into the coverage area 24, then the MN 26 updates the binding cache in the CN 30 by sending a BU message to the CN 30, indicating its new COA-C as the CoA associated with AR4. However, the MN 26 does not send a BU message to the HA 28 as long as it remains within the wide coverage area 12.

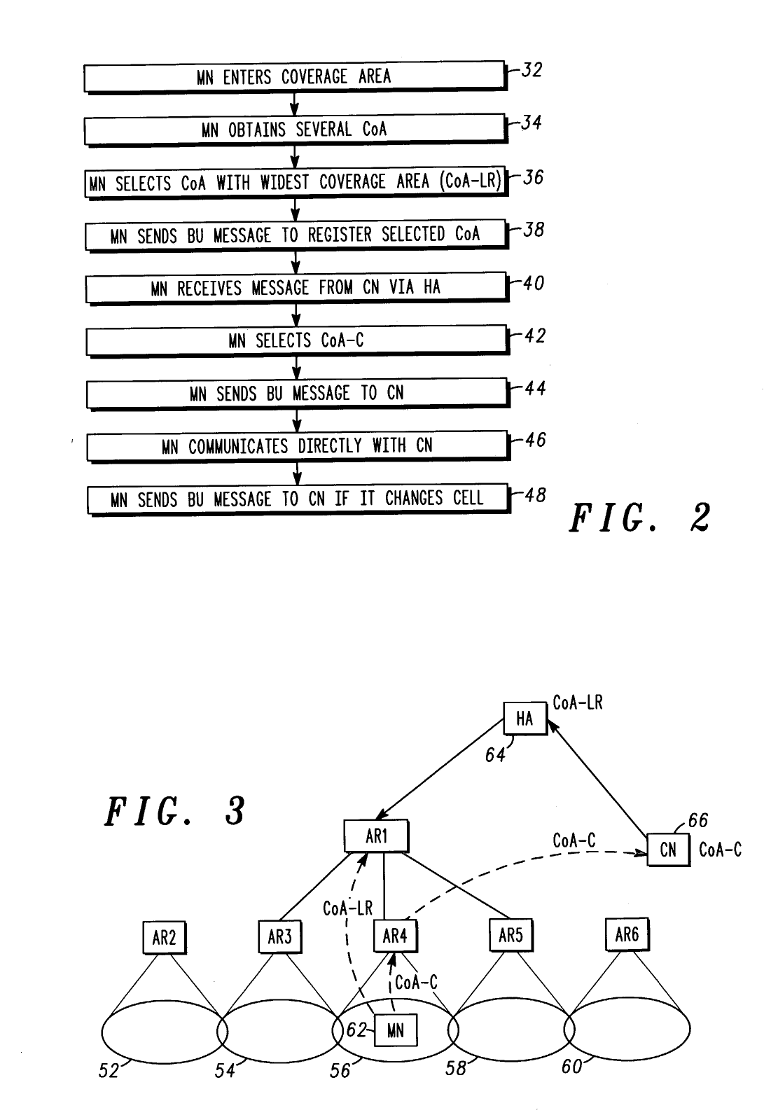

Referring now to FIG. 3, a diagram for explaining a second example of the location registration process of the present invention is shown. In FIG. 3, the network configuration includes first through sixth access routers AR1-AR6. The second through sixth access routers AR2-AR6 are small coverage systems, such as 802.11, Bluetooth, B3G cellular, etc. and define respective coverage areas 52-60. The first access router AR1 is in communication with the third through fifth access routers AR2-AR5 and forms a Virtual Local Area Network (VLAN) that includes the coverage areas 54, 56 and 58 of the third through fifth access routers AR3-AR5. Thus, the coverage areas 54, 56 and 58 belong to the IP subnet by the VLAN in addition to the IP subnets that are formed by AR3, AR4 and AR5 respectively. The coverage area 52 of AR2 overlaps the coverage area 54 of AR3. Similarly, the coverage area 58 of AR5 overlaps the coverage area 60 of AR6. As is known by those of skill in the art, a VLAN acts like an ordinary LAN except that connected devices do not have to be physically connected to the same segment. While multiple devices may be located anywhere on a network, they are grouped together by the VLAN and broadcasts are sent to devices within the VLAN.

A mobile node MN 62, which may be a cellular telephone, such as a 3G cellular telephone, a PDA, or a laptop computer, is shown in the coverage area 56 of AR4, which is within the VLAN. The MN 62 preferably uses Mobile IPv.6 for mobility management and is capable of communication by cellular service and hot spot service. The MN 62 may move from one coverage area to another and continue communicating via the network. The MN 62 has a home agent HA 64. Also shown is a correspondent node CN 66. In this example, the MN 62, upon entering the coverage area 56, receives CoAs from ART and AR4. That is, the router advertisement message from AR1 can reach the MN 62 via AR4 since broadcasts are delivered within a VLAN. The MN 62 also receives a router advertisement message from AR4. Consequently, the MN 62 receives multiple CoAs. Based upon first predetermined criteria, such as size of coverage area, the MN 62 selects one of the received CoAs as its location CoA, designated herein COA-LR. In this example, the MN 62 selects the CoA from ART as its CoA-LR, and registers the selected CoA-LR with the HA 64, because ART provides a broader coverage area than AR4. As long as the MN 62 remains within the area covered by the VLAN, the MN 62 does not need to send a BU message to the HA 64. Based upon second criteria, the MN 62 selects one of the received CoAs, designated COA-C for communication with the CN 66. In this example, the MN 62 selects the CoA of AR4 as its COA-C because AR4 provides a higher speed and lower cost connection. The MN 62 will then communicate with the CN 66 via AR4 using the COA-C by sending a BU message to the CN 66. The MN also sends a BU message to AR1 registering as its CoA-LR. As long as the MN 62 stays within the VLAN formed by AR1, it can use receive messages from AR1, such as paging messages. The MN 62 can simultaneously communicate with the CN 66 using the small coverage network facilities AR4, or AR3 or AR5 should it move to their respective coverage areas 54 and 58. The MN 62 does not need to send BU messages to the HA 64 while it stays in the coverage area designated by its COA-LR the VLAN formed by AR1.

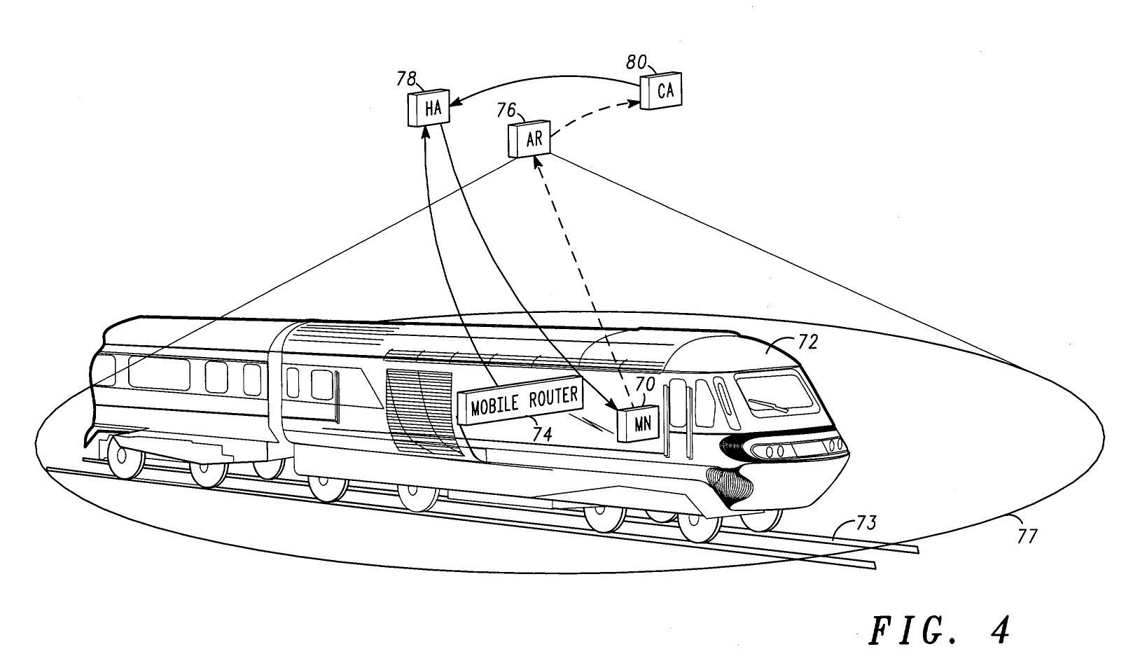

Referring now to FIG. 4, a diagram for explaining a third example of the location registration process of the present invention is shown. In FIG. 4, a MN 70 is located in a moving vehicle 72 such as a train moving along tracks 73. The moving vehicle 72 is equipped with a mobile router 74. At its present location, the MN 70 is located within a coverage area 77 of an access router AR 76. According to the present invention, the MN 70 receives a CoA from the mobile router 74 and a CoA from the access router AR 76. The MN 70 selects one of the received CoAs using predetermined criteria such as the size of the coverage area, bandwidth, or QoS. In this example, the MN 70 selects the mobile router 74 because the MN 70 can communicate via the mobile router 74 as it moves along the train route, which for most trips would mean passing through many coverage areas. The MN 70 registers with its home agent HA 78 using the selected CoA by sending BU message to the mobile router 74. The BU message registers the CoA of the mobile router 74 as the COA-LR.

The MN 70 can receive a communication from a correspondent node CN 80 by way of the HA 78 and the mobile router 74. For example, if the CN 80 sends a packet to the home address of the MN 70, the home agent HA 78 receives the packet and forwards it to the COA-LR, which is at the mobile router 74 and the mobile router 74 forwards the packet to the MN 70. The MN 70 then selects between the available wireless links, in this case the mobile router 74 and the access router 76, the most appropriate wireless link and its associated CoA for communicating with the CN 80 based on some predetermined criteria, such as QoS. In this example, the MN 70 opts to communicate via the AR 76 and thus the MN 70 sends a BU message to the CN 80 to register the CoA of the AR 76 as a CoA-C (Care of Address-Communication). The MN 70 and the CN 80 thereafter communicate via the AR 76. However, even though the MN 70 is communicating with the CN 80 via the AR 76, the MN 70 does not need to send BU messages to the HA 78 as long as the MN 70 is in the moving vehicle 72.

A key point of the present invention is that BU traffic from the MN to the HA is reduced. Thus, valuable air-time or frequency bandwidth is reserved. Reducing air traffic can also improve the paging mechanism in a mobile IP based network.

The description of the preferred embodiments of the present invention have been presented for purposes of illustration and description, but are not intended to be exhaustive or to limit the invention to the forms disclosed. Although the invention is described in terms of separate processing components, it will be understood by those of skill in the art the that invention may be implemented in hardware, software, or a combination of hardware and software. Thus, changes could be made to the embodiments described above without departing from the broad inventive concept thereof. It is understood, therefore, that this invention is not limited to the particular embodiments disclosed, but covers modifications within the spirit and scope of the present invention as defined by the appended claims.

1. A wireless communication method comprising the steps of:
a mobile node (MN) receiving a plurality of Care-of-Addresses (CoA) from a corresponding plurality of routers when the MN enters coverage areas of the routers;
the MN selecting one of the plurality of CoAs based on first predetermined criteria;
the MN registering the selected CoA as a location CoA (CoA-LR) with a Home Agent (HA) via a binding update message;
the MN receiving a packet from a correspondent node (CN) via the HA;
the MN selecting a link for communication with the CN based on second predetermined criteria; and
the MN sending a binding update message to the CN specifying a communication CoA (CoA-C) that allows the MN and the CN to communicate directly with each other.

2. The wireless communication method of claim 1, wherein the plurality of CoAs includes a CoA for each subnet within the router coverage area.

3. The wireless communication method of claim 2, wherein the first predetermined criteria includes a size of the coverage area.

4. The wireless communication method of claim 3, wherein the MN selects the CoA of the router with the largest coverage area.

5. The wireless communication method of claim 1, wherein the second predetermined criteria includes bandwidth and quality of service.

6. The wireless communication method of claim 1, wherein a paging message directed to the MN is sent via the HA using the CoA-LR and a message from a CN is sent to the MN using the COA-C.

7. A wireless communication method comprising the steps of:
a home agent (HA) communicating with a mobile node (MN) using a location Care-of-Address (CoA-LR), wherein the COA-LR designates a first wireless coverage area; and
a correspondent node (CN) communicating with the MN using a communication Care-of-Address (CoA-C), wherein the COA-C designates a second wireless coverage that is a sub-network of the first wireless coverage area.

8. The communications system of claim 7, wherein the second wireless coverage area comprises a Bluetooth network.

9. The communications system of claim 7, wherein the second wireless coverage area comprises a 802.11 type network.

10. The communications system of claim 7, wherein the first wireless coverage area comprises a cellular network.

11. The communications system of claim 7, wherein the first wireless coverage area comprises a satellite network.
